(19) United States
(12) Patent Application Publication
(10) Pub. No.: US 2026/0285432 A1
(43) Pub. Date: Sep. 24, 2026

(54) VEHICLE HORN

(71) Applicant: Indian Motorcycle International, LLC, Medina, MN (US)

(72) Inventors: Benjamin B. Gallup, Plymouth, MN (US); Adam D. Bennett, Lino Lakes, MN (US); Ronald A. Vorndran, Osceola, WI (US); Joshua J. Vorderbruggen, Clearbrook, MN (US); Mark R. Myhra, Elk River, MN (US); William H. Doornink, Star Prairie, WI (US)

(21) Appl. No.: 19/469,513

(22) PCT Filed: Mar. 27, 2024
(86) PCT No.: PCT/US2024/021659

§ 371 Date: Sep. 26, 2025

Related U.S. Application Data
(60) Provisional application No. 63/455,832, filed on Mar. 30, 2023.

(51) Int. Cl. B62J 3/12; B62J 6/027; B62J 17/02; H04R 1/02; H04R 1/30

(52) U.S. Cl. CPC B62J 3/12; B62J 6/027; B62J 17/02; H04R 1/025; H04R 1/30; H04R 2499/13

(57) ABSTRACT

A vehicle may comprise a bodywork, a fairing connected to the bodywork, a headlight connected to the bodywork, and a horn connected to the bodywork. The horn may be positioned vertically above the headlight, rearward of the fairing and/or forward of a portion of the bodywork. The horn may be positioned to direct sound at least partially forward of the fairing through an opening at least partially defined by the fairing.

### CROSS-REFERENCE TO RELATED APPLICATION

The present application claims the benefit of U.S. Provisional Application No. 63/455,832, entitled “VEHICLE HORN,” filed on Mar. 30, 2023, which is incorporated by reference herein for all purposes in its entirety.

### TECHNICAL FIELD

The present application relates generally to vehicle horns and more particularly to placement of a horn on a vehicle to reduce the visibility of the horn while maintaining sound performance.

### BACKGROUND

Typically, horns for vehicles such as motorcycles are mounted to the vehicle at a location that will permit the sound to emanate from the horn in an unobstructed fashion. However, positioning the horn at such a location may be considered aesthetically displeasing. Thus, it would be desirable to mount a horn in a concealed manner that does not degrade the sound performance of the horn.

### SUMMARY

According to one embodiment of the disclosure, a vehicle is provided, comprising: a bodywork; a fairing connected to the bodywork; a headlight connected to the bodywork; and a horn connected to the bodywork and positioned vertically above the headlight, rearward of the fairing and forward of a portion of the bodywork; wherein the horn is positioned to direct sound at least partially forward of the fairing through an opening at least partially defined by the fairing. In one aspect of this embodiment, the horn is mounted to the bodywork vertically between a top and a bottom extent of the fairing. Another aspect further comprises a bracket connected to the bodywork, the horn being connected to the bracket. In a variant of this aspect, the horn includes an outlet trumpet, the bracket positioning the horn such that the outlet trumpet is directed toward the opening. In a further variant, the outlet trumpet is directed downwardly and forwardly and is positioned vertically above the opening. In another aspect, the opening is between the headlight and a headlight bezel secured to the fairing. In a variant, the headlight is mounted to the bodywork inwardly and spaced apart from the headlight bezel. In another variant, the headlight bezel includes an annular wall that surrounds the headlight, the annular wall having an upper portion that at least partially defines the opening. In a further variant, the upper portion is substantially horizontal and forms an acute angle with a portion of the headlight adjacent the opening. In another aspect, the horn is not visible when viewing the vehicle from a front of the vehicle. In another aspect, the vehicle further comprises a sound directing tube mounted to the bodywork adjacent the horn, the sound directing tube including a lower opening to receive sound from the horn and a forward-facing opening for directing sound through a vent formed in the fairing. In a variant, the horn includes an outlet trumpet that faces rearwardly and upwardly to align with the lower opening of the sound directing tube. In another variant, the sound directing tube includes a tunnel and a main body, the tunnel including the lower opening which is in flow communication with an interior volume of the tunnel, the tunnel further including an upper opening that is in flow communication with an opening formed in a lower wall of the main body which is in flow communication with an interior volume of the main body. In another variant, the vent is defined by an upper wall, a pair of side walls and an upper surface of the fairing. In another aspect, the horn is an electromagnetic disk horn.

Another embodiment of the present disclosure provides a horn assembly for a vehicle, comprising: a horn; a bracket mounted to a bodywork of the vehicle; a fairing connected to the bodywork; and a headlight connected to the bodywork; wherein the bracket supports the horn vertically above the headlight, rearward of the fairing and forward of a portion of the bodywork; and wherein the fairing and the headlight at least partially define an opening, the horn being positioned to direct sound through the opening. In one aspect of this embodiment, the horn includes an outlet trumpet, the bracket positioning the horn such that the outlet trumpet is directed toward the opening. In a variant of this aspect, the outlet trumpet is directed downwardly and forwardly and is positioned vertically above the opening. In another aspect, the opening is between the headlight and a headlight bezel secured to the fairing. In a further variant, the headlight bezel includes an annular wall that surrounds the headlight, the annular wall having an upper portion that at least partially defines the opening. In yet a further variant, the upper portion is substantially horizontal and forms an acute angle with a portion of the headlight adjacent the opening. In another aspect, the horn is an electromagnetic disk horn.

### BRIEF DESCRIPTION OF THE DRAWINGS

The above mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a perspective view of a vehicle according to one embodiment of the present disclosure;

FIG. 2 is another perspective view of the vehicle of FIG. 1;

FIG. 3 is a perspective view of a sound directing tube according to one embodiment of the present disclosure;

FIG. 4 is a cross-sectional view of the vehicle of FIG. 2;

FIG. 5A is a perspective view of a vehicle according to another embodiment of the present disclosure;

FIG. 5B is a cross-sectional view of the vehicle of FIG. 5; and

FIG. 6 is a perspective view of a portion of the vehicle of FIG. 5.

Corresponding reference characters may indicate corresponding parts throughout the several views.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated.

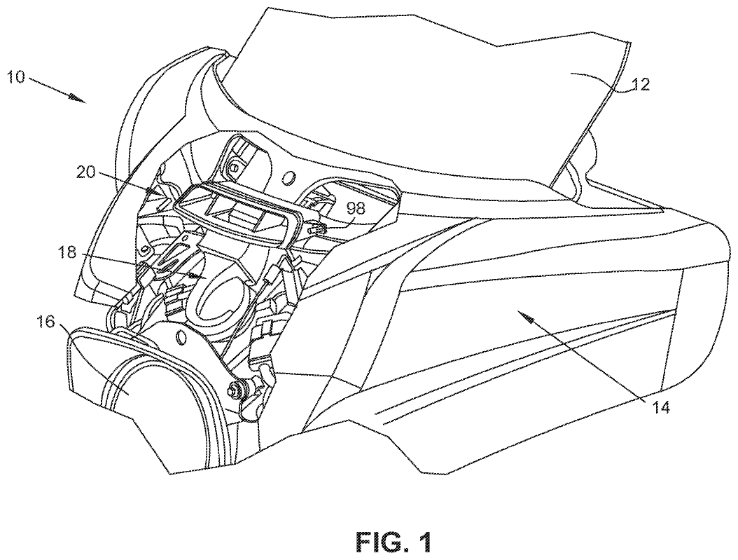

Referring now to FIG. 1, one embodiment of a vehicle having a horn mounted according to the present disclosure is shown. The vehicle 10, in this embodiment, is a motorcycle including, among other things, a windshield 12, forward bodywork 14, and a headlight 16. As shown, a horn 18 is mounted to the bodywork 14 at a location vertically between the headlight 16 and the windshield 12. A sound directing tube 20 is mounted to the bodywork 14 adjacent the horn 18 as is further described below.

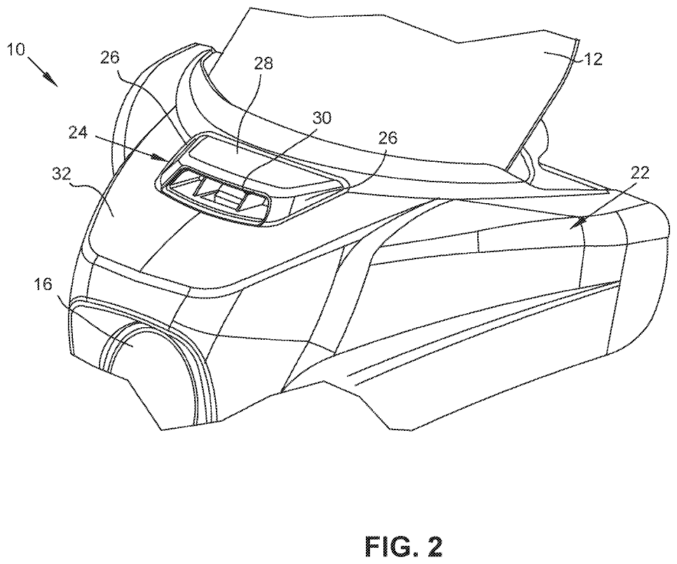

Referring now to FIG. 2, a fairing 22 is shown mounted to the bodywork 14 thereby enclosing the horn 18 and the tube 20. The fairing 22 includes an upper vent 24 having a pair of side walls 26, an upper wall 28 and a forward facing opening 30. An upper surface 32 of the fairing 22 cooperates with the side walls 26 and the upper wall to define the opening 30.

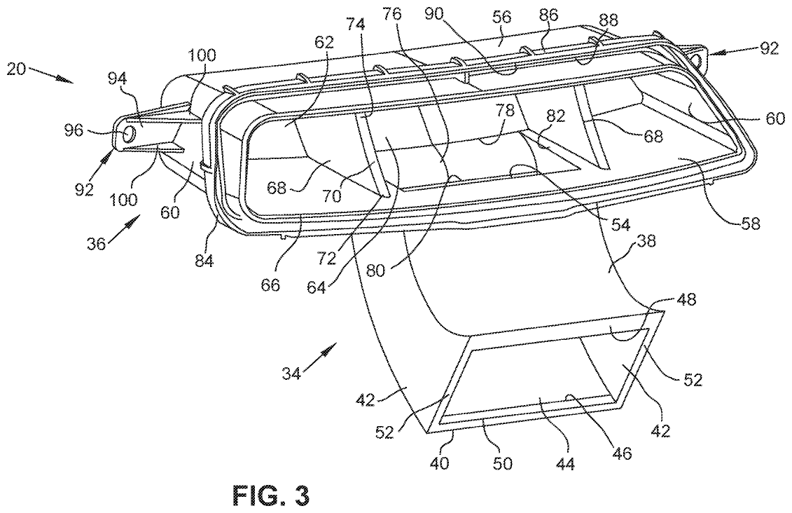

As best shown in FIG. 3, the tube 20 generally includes a tunnel 34 and a main body 36. The tunnel 34 includes an upper wall 38, a lower wall 40, and a pair of side walls 42. The upper wall 38, the lower wall 40, and the side walls 42 define an interior volume 44. The tunnel 34 further includes a lower opening 46 defined by an upper edge 48, a lower edge 50 and a pair of side edges 52. The lower opening 46 is in flow communication with the interior volume 44. In the depicted embodiment, the lower opening 46 is rectangular in shape. In certain embodiments, the upper wall 38, the lower wall 40 and the side walls 42 are curved as shown, thereby forming a curved tunnel 34 and a curved interior volume 44. The tunnel 34 further includes an upper opening 54 in flow communication with the interior volume 44. As described below, the upper opening 54 is formed in a lower wall of the main body 36 of the tube 20.

The main body 36 of the tube 20 generally includes an upper wall 56, a lower wall 58, a pair of side walls 60 and a rear wall 62. The walls 56-62 define a partially enclosed interior volume 64. The upper wall 56, the lower wall 58 and the side walls 60 define a forward facing opening 66 that is in flow communication with the interior volume 64. A pair of internal walls 68 extend between the upper wall 56, the lower wall 58 and the rear wall 62. Each of the internal walls 68 has an angled front edge 70 having a lower end 72 and an upper end 74. The front edge 70 is angled toward the rear wall 62 of the main body 36 with distance from the lower end 72 to the upper end 74. The lower wall 58 of the main body 36 includes an opening 76 that corresponds to the upper opening 54 of the tunnel 34. The opening 76 has a rear edge 78 adjacent the rear wall 62 of the main body 36, a forward edge 80, and a pair of side edges 82 that are adjacent but spaced apart from the internal walls 68.

The main body 36 of the tube 20 further includes a perimeter flange 84 that extends along the upper wall 56, the side walls 60 and the lower wall 58 and is spaced rearwardly of the forward facing opening 66. The perimeter flange 84 includes a rear wall 86 that extends outwardly from the main body 36 and a mating wall 88 that extends forwardly from the rear wall 86, thereby defining a recess 90 between the flange 84 and the upper wall 56, the side walls 60 and the lower wall 58. As is further described below, the recess 90 is configured to receive mating flanges adjacent the opening 30 of the upper vent 24 of the fairing 22.

Finally, the main body 36 also includes a pair of mounting brackets 92. Each mounting bracket 92 includes a mounting wall 94 that extends laterally away from one of the side walls 60 of the main body 36. The mounting wall 94 includes an opening 96 for receiving a fastener 98 (FIG. 1) to mount the tube 20 to the bodywork 14. Each bracket 92 also includes a pair of ribs 100 to reinforce and strengthen the connection between the bracket 92 and the side wall 60.

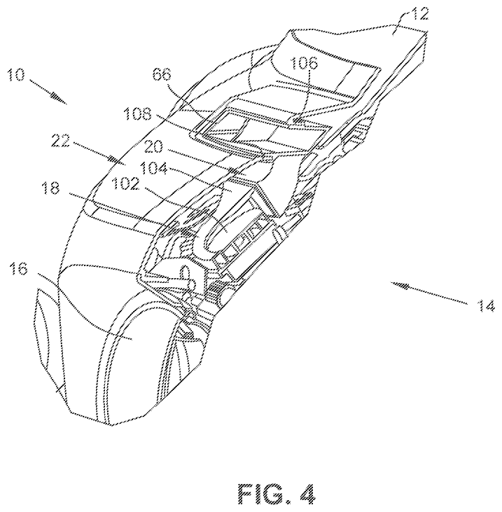

Referring now to FIG. 4, the tube 20 is shown mounted to the bodywork 14 and engaged with the fairing 22. Additionally, the horn 18 is shown mounted to the bodywork 14 and coupled to the tube 20. The horn 18 may be a horn manufactured by Seger. The horn 18 generally includes a volute 102 that spirals from a central location to an outlet trumpet 104. An electromagnet (not shown) near the central portion of the horn 18, when activated, causes a diaphragm (not shown) to vibrate, creating sound waves which travel through the volute and exit the outlet trumpet 104. Typically, the horn 18 is activated by the driver of the vehicle 10 by pressing a button or switch (not shown) mounted in the driver area of the vehicle 10. The button or switch delivers power from a power source (not shown) to the electromagnet over wires (not shown). It should be understood that other types of horns may be used, such as air actuated horns or other types of electromagnetic horns such as disk horns using a diaphragm directly exposed to the environment instead of a trumpet.

Again as shown in FIG. 4, the horn 18 is mounted to the bodywork 14 such that the outlet trumpet 104 is facing rearwardly and upwardly to align with the lower opening 46 of the tunnel 34 of the tube 20. The outlet trumpet 104 is operably associated with the lower opening 46 such as by being positioned adjacent the opening 46, positioned partially within the opening 46, or connected to the opening 46. The tube 20 is engaged with the upper vent 24 of the fairing 22 as shown. More specifically, the upper wall 28 of the upper vent 24 includes a rearwardly projecting mating flange 106 and the side walls 26 include rearwardly projecting mating flanges (not shown). Additionally, the upper surface 32 of the fairing 22 adjacent the opening 30 includes a rearwardly projecting mating flange 108. The mating flanges 106, 108 are received by the perimeter recess 90 formed around the main body 36 of the tube 20 by the perimeter flange 84. The engagement between the mating flanges 106, 108 and the recess 90 may be through an adhesive joint, clips or other mechanical fasteners, a friction fit or other type of connection. When the driver actuates the horn 18 in the manner described above, the sound travels from the central portion of the volute 102, through the outlet trumpet 104, into the lower opening 46 of the tunnel 34, through the interior volume 44 of the tunnel 34, into the interior volume 64 of the main body 36 through the opening 76, and out of the main body 36 through the forward facing opening 66.

The manner of mounting the horn 18 and tube 20 to direct sound though the opening 30 in the upper vent 24 of the fairing 22 as described above conceals the horn 18 and while still providing acceptable sound performance of the horn 18. In other words, the mounting and orientation of the horn 18 and the tube 20 adds functionality to the otherwise primarily decorative fairing vent 24 to retain forward directed sound propagation of the horn 18 while improving the appearance of the vehicle 10.

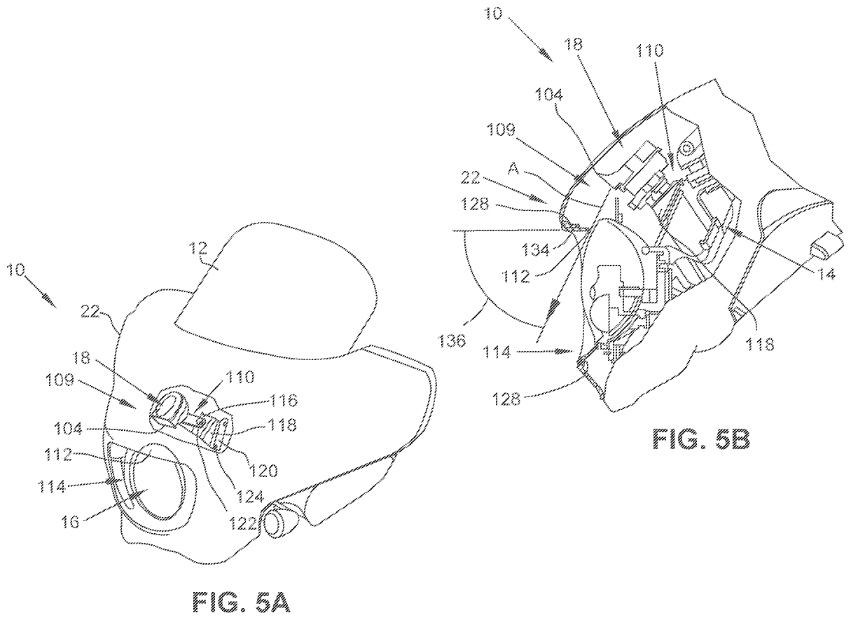

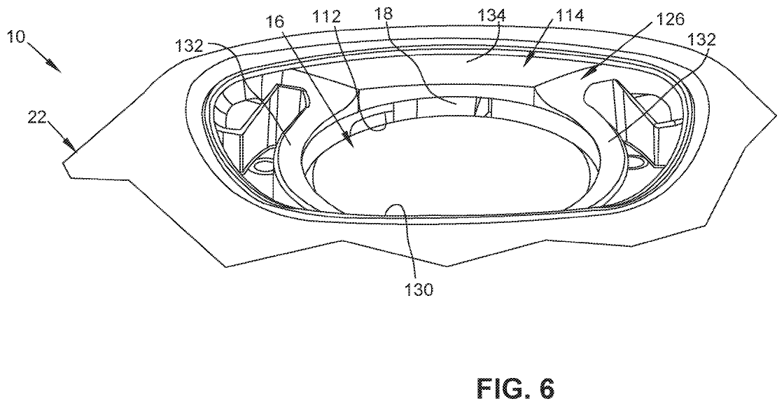

Referring now to FIGS. 5A and 5B, another embodiment of a vehicle having a horn assembly mounted according to the present invention is shown. For purposes of description, like components are identified using the same reference designations used above with reference to FIGS. 1-4. In this embodiment, the horn assembly 109 includes a horn 18 mounted to a bracket 110 connected to the bodywork 14 such that the outlet trumpet 104 of the horn 18 faces downwardly and forwardly toward a gap or opening 112 (best shown in FIG. 6) between the headlight 16 and the headlight bezel 114. As shown, the bracket 110 includes a base 116 to which the horn 18 is attached, a pair of legs 118 (one shown) extending from the base 116 toward the bodywork 14, and a pair of mounting plates 120 (one shown) extending from the legs 118. As best shown in FIG. 5B, the legs 118 are triangular in shape and, when the bracket 110 is attached to the bodywork 14, direct the outlet trumpet 104 of the horn 18 toward the opening 112. The horn 18 is attached to the base 116 of the bracket 110 using fasteners 122 and the mounting plates 120 are attached to the bodywork 14 using fasteners 124. The bracket 110 is made from rigid material such as steel, and may be selected to be unaffected by the natural frequency of the horn 18.

As shown FIG. 6, the headlight bezel 114 includes an annular wall 126 which is attached to the fairing 22 using a plurality of engagement features 128 (two shown in FIG. 5B). The annular wall 126 includes a lower portion 130, a pair of side portions 132 and an upper portion 134. The headlight 16 is mounted to the bodywork 14 inwardly and spaced apart from the bezel 114 such that the opening 112 is formed between the headlight 16 and at least the upper portion 134 and the side portions 132 of the bezel 114. As best shown in FIG. 5B, the upper portion 134 of the annular wall 126 of the bezel 114 is substantially horizontal and forms an acute angle 136 with a portion of the headlight 16 adjacent the opening 112. As is also best shown in FIG. 5B, the horn 18 is positioned by the bracket 110 such that the outlet trumpet 104 of the horn 18 is spaced apart from the opening 112 by a distance A. The distance A may permit insects, road debris and/or the elements to drop down behind the headlight 16 and through the bodywork 14 instead of potentially entering into the outlet trumpet 104 of the horn 18. It should be understood, however, that in alternative embodiments the horn 18 may be positioned closer to the opening 112 than distance A, or a tunnel or a sound directing tube may be positioned between the horn 18 and the opening 112.

As should be apparent from the foregoing, the horn 18 is placed inside the fairing 22 in an isolated position which reduces the risk of water and debris from entering the horn 18 as a result of driving the vehicle 10. Additionally, the horn 18 is not visible from the front of the vehicle 10 and is protected by the fairing 22 and the headlight 16. The opening 112 is configured to direct the sound forward and to the sides of the vehicle 10, which permits the horn 18 to perform the function of notifying nearby people or animals of the existence of the vehicle 10. Moreover, the opening 112 is downward facing and hidden from view when the vehicle 10 is viewed at eye level in part by the upper portion 134 of the bezel 114. Additionally, a concealed horn 18 may require a more powerful horn to comply with governmental regulations. In the embodiments described herein, the concealed horn 18 may be relatively less powerful and still comply with regulations because the openings permit the sound to exit the bodywork 14 and direct the sound in the desired direction (i.e., primarily forward). This saves expense and weight, which be important parameters on a vehicle 10 such as a motorcycle.

The following items are further variations and examples of the embodiments described with reference to the figures.

Example 1. A vehicle may comprise a bodywork. The vehicle may further comprise a fairing connected to the bodywork. The vehicle may further comprise a headlight connected to the bodywork. The vehicle may further comprise a horn connected to the bodywork. The horn may be positioned vertically above the headlight, rearward of the fairing and/or forward of a portion of the bodywork. The horn may be positioned to direct sound at least partially forward of the fairing through an opening. The opening may be at least partially defined by the fairing.

Example 2. The vehicle of Example 1, wherein the horn may be mounted to the bodywork vertically between a top and a bottom extent of the fairing.

Example 3. The vehicle of Example 1, may further comprise a bracket connected to the bodywork. The horn may be connected to the bracket.

Example 4. The vehicle of Example 3, wherein the horn may include an outlet trumpet. The bracket positioning the horn such that the outlet trumpet may be directed toward the opening.

Example 5. The vehicle of Example 4, wherein the outlet trumpet may be directed downwardly and forwardly and may be positioned vertically above the opening.

Example 6. The vehicle of Example 1, wherein the opening may be between the headlight and a headlight bezel secured to the fairing.

Example 7. The vehicle of Example 6, wherein the headlight may be mounted to the bodywork inwardly and spaced apart from the headlight bezel.

Example 8. The vehicle of Example 6, wherein the headlight bezel may include an annular wall that surrounds the headlight. The annular wall may have an upper portion that at least partially defines the opening.

Example 9. The vehicle of Example 8, wherein the upper portion may be substantially horizontal and may form an acute angle with a portion of the headlight adjacent the opening.

Example 10. The vehicle of Example 1, wherein the horn may be not visible when viewing the vehicle from a front of the vehicle.

Example 11. The vehicle of Example 1, may further comprise a sound directing tube mounted to the bodywork adjacent the horn. The sound directing tube may include a lower opening to receive sound from the horn and a forward-facing opening for directing sound through a vent formed in the fairing.

Example 12. The vehicle of Example 11, wherein the horn may include an outlet trumpet that faces rearwardly and upwardly to align with the lower opening of the sound directing tube.

Example 13. The vehicle of Example 11, wherein the sound directing tube may include a tunnel and a main body. The tunnel may include the lower opening which is in flow communication with an interior volume of the tunnel. The tunnel may further include an upper opening that is in flow communication with an opening formed in a lower wall of the main body which is in flow communication with an interior volume of the main body.

Example 14. The vehicle of Example 11, wherein the vent may be defined by an upper wall, a pair of side walls and an upper surface of the fairing.

Example 15. The vehicle of Example 1, wherein the horn may be an electromagnetic disk horn.

Example 16. A horn assembly for a vehicle may comprise a horn and a bracket. The bracket may be mounted to a bodywork of the vehicle. The horn assembly may further comprise a fairing which may be connected to the bodywork. The horn assembly may further comprise a headlight connected to the bodywork. The bracket may support the horn vertically above the headlight, rearward of the fairing and forward of a portion of the bodywork. The fairing and the headlight may at least partially define an opening. The horn may be positioned to direct sound through the opening.

Example 17. The horn assembly of Example 16, wherein the horn may include an outlet trumpet. The bracket may position the horn such that the outlet trumpet is directed toward the opening.

Example 18. The horn assembly of Example 17, wherein the outlet trumpet may be directed downwardly and forwardly and may be positioned vertically above the opening.

Example 19. The horn assembly of Example 16, wherein the opening may be between the headlight and a headlight bezel secured to the fairing.

Example 20. The horn assembly of Example 19, wherein the headlight bezel may include an annular wall that surrounds the headlight. The annular wall may have an upper portion that at least partially defines the opening.

Example 21. The horn assembly of Example 20, wherein the upper portion may be substantially horizontal. The upper portion may forms an acute angle with a portion of the headlight adjacent the opening.

Example 22. The horn assembly of Example 16, wherein the horn may be an electromagnetic disk horn.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A vehicle, comprising:
a bodywork;
a fairing connected to the bodywork;
a headlight connected to the bodywork; and
a horn connected to the bodywork and positioned vertically above the headlight, rearward of the fairing and forward of a portion of the bodywork;
wherein the horn is positioned to direct sound at least partially forward of the fairing through an opening at least partially defined by the fairing.

2. The vehicle of claim 1, wherein the horn is mounted to the bodywork vertically between a top and a bottom extent of the fairing.

3. The vehicle of claim 1, further comprising a bracket connected to the bodywork, the horn being connected to the bracket.

4. The vehicle of claim 3, wherein the horn includes an outlet trumpet, the bracket positioning the horn such that the outlet trumpet is directed toward the opening.

5. The vehicle of claim 4, wherein the outlet trumpet is directed downwardly and forwardly and is positioned vertically above the opening.

6. The vehicle of claim 1, wherein the opening is between the headlight and a headlight bezel secured to the fairing.

7. The vehicle of claim 6, wherein the headlight is mounted to the bodywork inwardly and spaced apart from the headlight bezel.

8. The vehicle of claim 6, wherein the headlight bezel includes an annular wall that surrounds the headlight, the annular wall having an upper portion that at least partially defines the opening.

9. The vehicle of claim 8, wherein the upper portion is substantially horizontal and forms an acute angle with a portion of the headlight adjacent the opening.

10. The vehicle of claim 1, wherein the horn is not visible when viewing the vehicle from a front of the vehicle.

11. The vehicle of claim 1, further comprising a sound directing tube mounted to the bodywork adjacent the horn, the sound directing tube including a lower opening to receive sound from the horn and a forward-facing opening for directing sound through a vent formed in the fairing.

12. The vehicle of claim 11, wherein the horn includes an outlet trumpet that faces rearwardly and upwardly to align with the lower opening of the sound directing tube.

13. The vehicle of claim 11, wherein the sound directing tube includes a tunnel and a main body, the tunnel including the lower opening which is in flow communication with an interior volume of the tunnel, the tunnel further including an upper opening that is in flow communication with an opening formed in a lower wall of the main body which is in flow communication with an interior volume of the main body.

14. The vehicle of claim 11, wherein the vent is defined by an upper wall, a pair of side walls and an upper surface of the fairing.

15. The vehicle of claim 1, wherein the horn is an electromagnetic disk horn.

16. A horn assembly for a vehicle, comprising:
a horn;
a bracket mounted to a bodywork of the vehicle;
a fairing connected to the bodywork; and
a headlight connected to the bodywork;
wherein the bracket supports the horn vertically above the headlight, rearward of the fairing and forward of a portion of the bodywork; and
wherein the fairing and the headlight at least partially define an opening, the horn being positioned to direct sound through the opening.

17. The horn assembly of claim 16, wherein the horn includes an outlet trumpet, the bracket positioning the horn such that the outlet trumpet is directed toward the opening.

18. The horn assembly of claim 17, wherein the outlet trumpet is directed downwardly and forwardly and is positioned vertically above the opening.

19. The horn assembly of claim 16, wherein the opening is between the headlight and a headlight bezel secured to the fairing.

20. The horn assembly of claim 19, wherein the headlight bezel includes an annular wall that surrounds the headlight, the annular wall having an upper portion that at least partially defines the opening.

21. The horn assembly of claim 20, wherein the upper portion is substantially horizontal and forms an acute angle with a portion of the headlight adjacent the opening.

22. The horn assembly of claim 16, wherein the horn is an electromagnetic disk horn.
